(19) United States
(12) Patent Application Publication
(10) Pub. No.: US 2012/0061209 A1
(43) Pub. Date: Mar. 15, 2012

(54) CONVEYOR MODULE, PARTICULARLY FOR A BAND CONVEYOR, WITH IMPROVED MEANS FOR CONNECTING ADDITIONAL MEMBERS

(75) Inventors: Andrea MEMOLI, Grumello Del Monte (BG) (IT); Ted Van Der Hoeven, De Lier (NL)

(73) Assignee: SYSTEM PLAST S.r.l., Telgate (BG) (IT)

(21) Appl. No.: 13/228,789

(22) Filed: Sep. 9, 2011

(30) Foreign Application Priority Data
Sep. 10, 2010 (IT) MI2010A 001647

(51) Int. Cl. B65G 17/40; B23P 11/00; B65G 17/46

(52) U.S. Cl. 198/699.1; 198/853; 29/428

(57) ABSTRACT

A module for forming a conveyor, particularly a band conveyor, presenting a plurality of modules connected together, each module including: an upper surface, a lower surface, conventional elements for removably connecting the modules together to form the conveyor, and connection element for removably connecting additional members, particularly a thrust bar, to the upper surface; in which the connection element includes, on the exposed face of the upper surface of the module, at least one predefined identification mark, the module presenting, below the upper surface in a position corresponding with the at least one predefined mark, at least one connection element extending from and closed by the upper surface and provided with, or in which there can be provided, a seat or hole adapted to cooperate with means, to removably connect the additional member to the upper surface of the module.

### CROSS REFERENCE TO RELATED APPLICATION

This application claims priority under 35 USC §119 from Italian Application No. MI2010A 001647, filed on Sep. 10, 2010, incorporated herein by reference.

### FIELD OF THE INVENTION

The present invention relates to a module for a conveyor formed by connecting together a plurality of said modules.

### BACKGROUND OF THE INVENTION

Modules of the aforedescribed type have been known for some time and they are described for example in document US 2004/238329. For certain applications, for example in the mechanical field, these conveyors present spaced-apart additional members, for example thrust bars, removably connected to the upper surface of the modules, and suitably spaced apart. Modules presenting said thrust bars are known by the expert of the art to be subject to greater wear hence, after a certain period of conveyor use, the thrust bars are moved onto other modules not previously associated with said thrust bars in order to prevent excessive deterioration of these bars. The operations required to connect the additional members to the modules are relatively lengthy and complicated.

### SUMMARY OF THE INVENTION

An object of the present invention is to provide a module which overcomes the above drawbacks by facilitating and simplifying the operations required to connect to the module an additional member, for example a thrust bar, while at the same time enabling modules to be formed which are lighter and use less material than traditional modules.

This and other objects which will be apparent to an expert of the art are attained by a module conforming to the characterising part of the accompanying claims.

The invention provides a module for forming a conveyor, particularly a band conveyor, presenting a plurality of said modules connected together, each module comprising: an upper surface, a lower surface, conventional elements for removably connecting the modules together to form said conveyor, and means for removably connecting additional members (8), particularly a thrust bar, to said upper surface; in which the connection means comprise, on the exposed face of the upper surface of the module, at least one predefined identification mark, the module presenting, below said upper surface in a position corresponding with said at least one predefined mark, at least one connection element extending from and closed by said upper surface and provided with, or in which there can be provided, a seat or hole adapted to cooperate with means, to removably connect said additional member to said upper surface of the module.

The invention also provides a method for removably connecting additional members, in particular a thrust bar, to the upper surface of a module claimed in one or more of the preceding claims, characterised by comprising an initial step in which said module upper surface is drilled at least one predefined mark provided on the module upper surface until reaching underlying predefined holes defined by an underlying element, said hole being adapted to cooperate with the means for removably connecting said additional member to the module.

### BRIEF DESCRIPTION OF THE INVENTION

The invention will be better understood from the accompanying figures, which are provided by way of non-limiting example and in which:

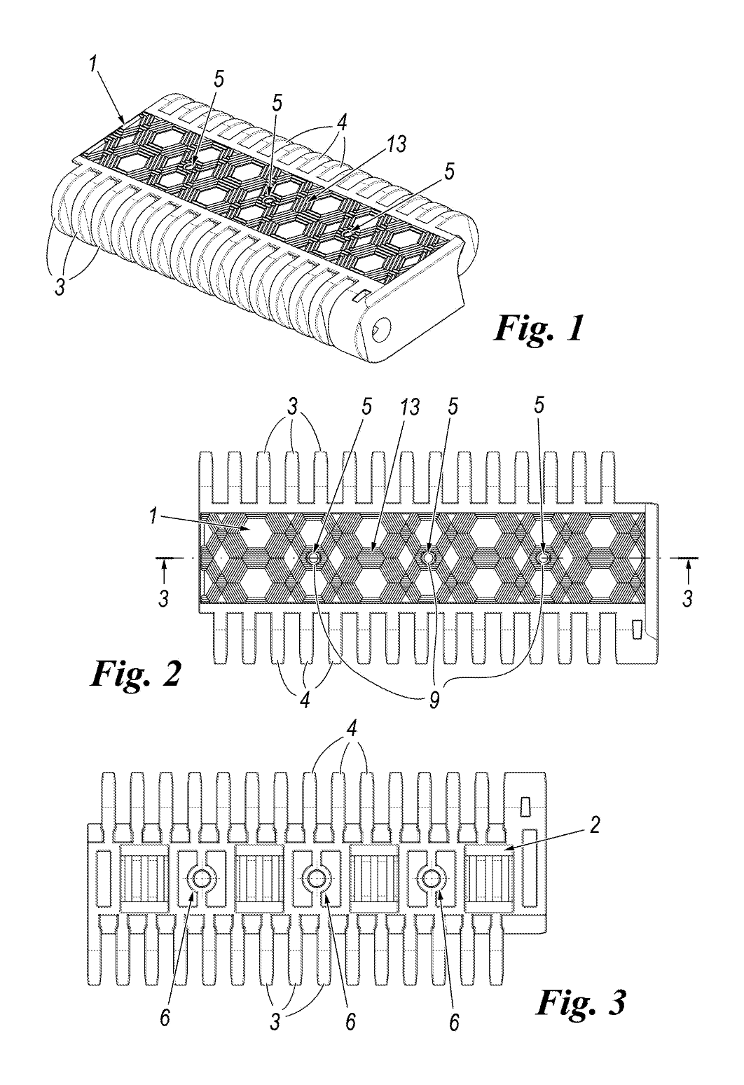

FIG. 1 is a perspective view of a module according to the invention,

FIG. 2 is a view of the module from above,

FIG. 3 is a view from below,

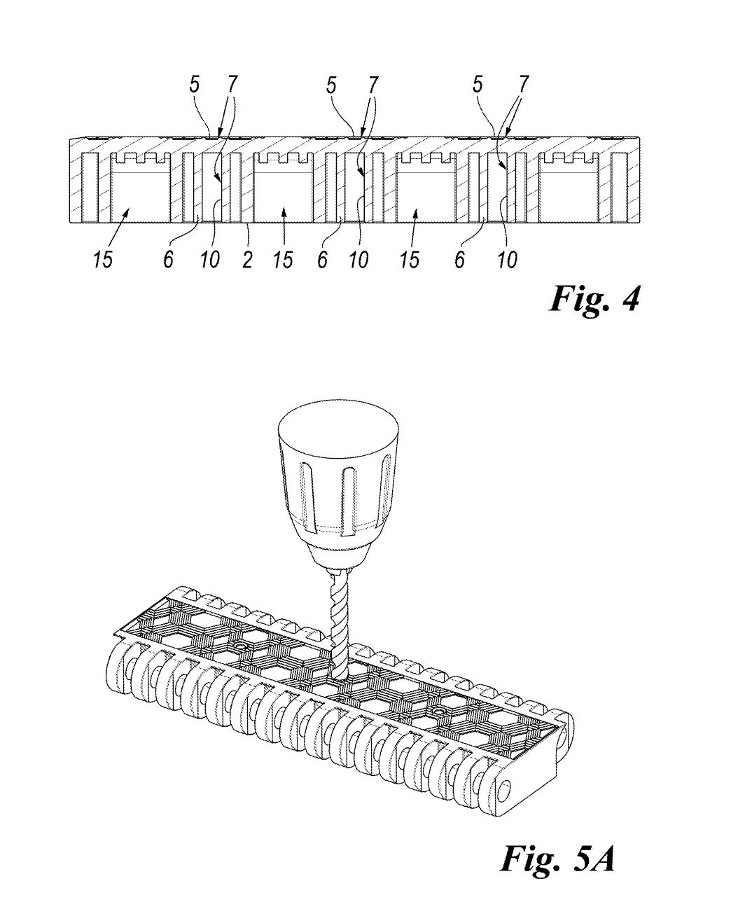

FIG. 4 is an enlarged cross-sectional view taken on the line 3-3 of FIG. 1,

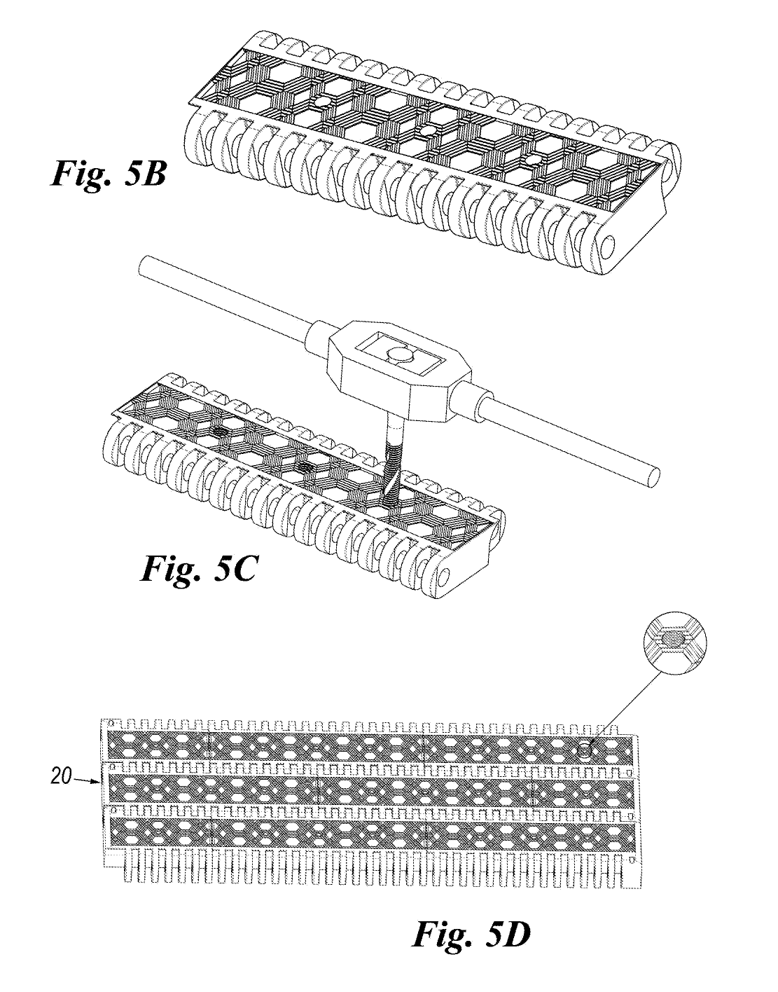

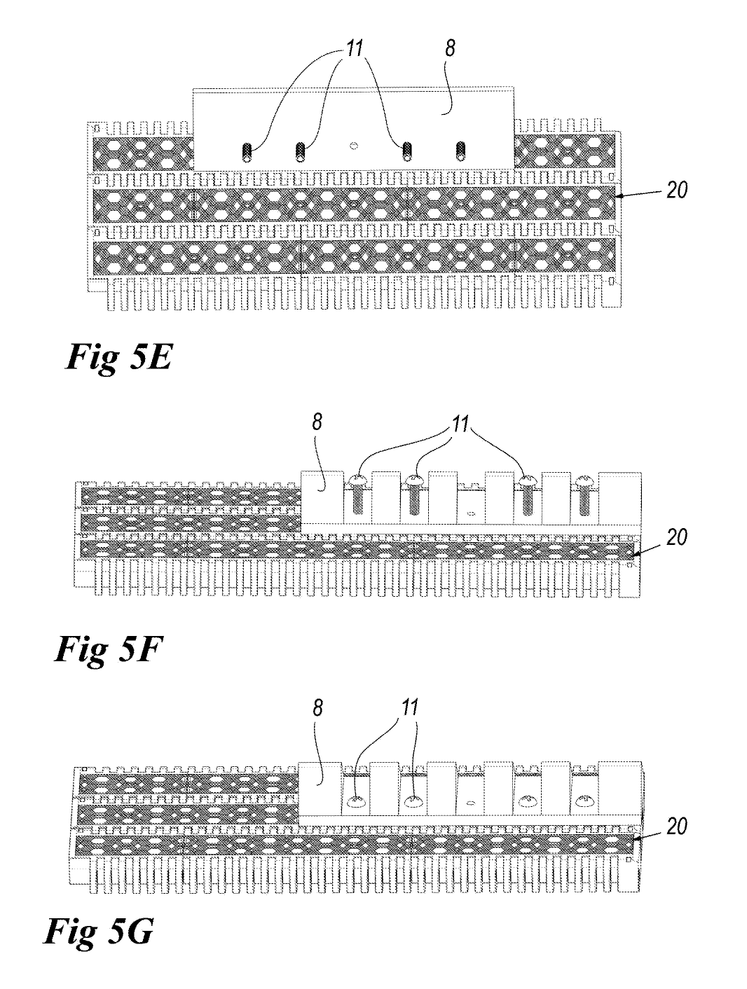

FIGS. 5A-G are schematic views showing the operations required to connect an additional bar member to the upper surface of the modules of a conveyor according to the invention,

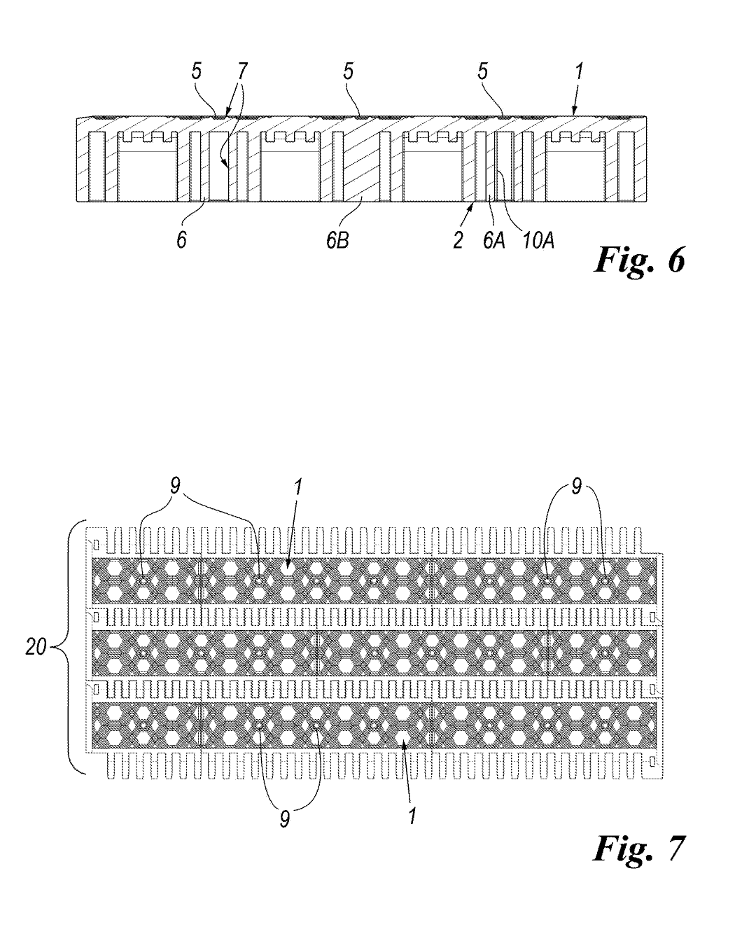

FIG. 6 is a sectional view, such as that of FIG. 4, of a second embodiment of the module according to the invention,

FIG. 7 shows a portion of a band conveyor formed from a plurality of modules of the invention, free of additional members.

### DETAILED DESCRIPTION OF THE PREFERRED EMBODIMENTS

With reference to FIGS. 1-4, these show a module adapted to form a conveyor, particularly a band conveyor 20 (a portion of which is shown schematically in FIG. 7), presenting a plurality of said modules connected together.

Each module comprises: an upper surface 1, a lower surface 2, conventional elements 3, 4 for removably connecting the modules together to form said conveyor, and means 7 (FIG. 4) for removably connecting additional members 8, particularly a thrust bar, to said upper surface. According to the invention, the connection means 7 comprise, on the upper surface 1 of the module, at least one portion 5 presenting a predefined identification mark 9 (FIG. 2). Again according to the invention, the module comprises, below the upper surface 1 in a position corresponding with this predefined mark, a hole 10 or seat defined by a connection element 6, in which means 11 can be engaged (FIG. 5) to removably connect said additional member to said upper surface of the module. The hole is advantageously of size M8 (a standard size in the metric system).

The module upper surface 1 is preferably a continuous surface free of holes or recessed seats for cooperating with the usual means 11 for connecting the additional members 8.

In addition to an optional usual relief knurling 13, the module upper surface 1 presents three portions 5 each provided with a conventional mark 9 in the form of a relief circle.

Immediately below each circle-shaped connection means 9, the module presents a connection element 6, which is preferably of tubular form with a circular cross-section, is open only at the module lower surface 2, and defines a hole 10 closed by the module upper surface 1.

The module of the invention is advantageously provided below the upper surface 1 with a plurality of predefined holes, not visible from the upper surface, but identified on said surface by the marks 9.

According to the invention, as shown in FIG. 5, if a thrust bar 8 is to be connected to one or more modules of a band conveyor 20, the upper surface 1 of the module is firstly drilled at the predefined marks 9 (FIG. 5A) to connect said surface 1 to the underlying holes 10, then the holes 10 are threaded (FIGS. 5C, 5D). In this manner the thrust bar 8 can be connected to the module in conventional manner, by usual screws which engage in the previously formed threaded holes (FIGS. 5E-G).

As the modules of the invention present the holes in predetermined positions, clearly indicated on the module upper surface, the operation of connecting a thrust bar to the module is made very simple and rapid. Moreover in the modules of the invention, the bar connection holes are made only if strictly necessary, to hence enable a module upper surface which, where it is not necessary to connect a bar thereto, is substantially continuous and free of holes or recessed seats into which dirt could enter and/or which would make conveyor cleaning more difficult.

According to a first variant of the invention, shown in FIG. 6, the hole 10A of the tubular element 6A presents a thread which further simplifies the operations necessary for connecting a bar to the module by reducing them to the mere need to drill the upper surface 1 at the predetermined mark 5.

According to a further variant of the invention, again shown in FIG. 6, below the predefined mark 5 an element 6B is provided which is solid rather than bored as previously described, but still enabling a seat, i.e. a threaded hole, to be formed therein for the screws connecting the bar to the module.

The invention is able to limit the quantity of plastic material required to form the module, as the tubular elements 6, 6A or solid elements 6B need to be provided only to correspond with the marks 5, whereas the adjacent zones can be empty (these empty zones being indicated by 15 in FIG. 4).

1. A module for forming a conveyor, presenting a plurality of said modules connected together,
each module comprising:
an upper surface, a lower surface, conventional elements for removably connecting the modules together to form said conveyor, and means for removably connecting additional members, to said upper surface,
on the exposed face of the upper surface of the module is presented at least one predefined identification mark,
the module presenting, below said upper surface in a position corresponding with said at least one predefined mark, at least one connection element presenting a hole closed by said upper surface and opened by said lower surface,
said hole being adapted to cooperate with said means, to removably connect said additional member to said upper surface of the module when said upper surface is drilled at said predefined mark for the insertion in said hole said connecting means.

2. A module as claimed in claim 1, wherein the module upper surface is a continuous surface free of holes or recessed seats for cooperating with the means for connecting the additional members.

3. A module as claimed in claim 1, wherein the predefined mark is substantially in the form of a circle or a dot.

4. A module as claimed in claim 1, wherein the connection element is of tubular form with a circular cross-section, is open only at the module lower surface, and defines a hole closed by the module upper surface.

5. A module as claimed in claim 1, comprising below the upper surface a plurality of predefined holes, which are not visible from the upper surface, but are identified on said surface by the marks.

6. A module as claimed in claim 1, wherein the hole of the connection element comprises a thread.

7. A module as claimed in claim 1, wherein the hole of the connection element has dimensions M8.

8. A method for removably connecting additional members to the upper surface of a module as claimed in claim 1, comprising:
an initial step in which said module upper surface is drilled at least one predefined mark provided on the module upper surface until reaching underlying predefined holes defined by an underlying element, said hole being adapted to cooperate with the means for removably connecting said additional member to the module.

9. A method as claimed in claim 8, comprising forming a thread in the hole after the drilling step.

10. A module as claimed in claim 1, wherein the conveyor is a band conveyor.

11. A module as claimed in claim 1, wherein the additional members comprise a thrust bar.

12. A method as claimed in claim 8, wherein the additional members comprise a thrust bar.
